(19) United States
(12) Patent Application Publication
(10) Pub. No.: US 2007/0101325 A1
(43) Pub. Date: May 3, 2007

(54) System and method for utilizing a remote memory to perform an interface save/restore procedure

(76) Inventors: Juraj Bystricky, Richmond (CA); Doug McFadyen, Delta (CA); Keith Kejser, New Westminster (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/253,449

(22) Filed: Oct. 19, 2005

(51) Int. Cl. G06F 9/46

(52) U.S. Cl. 718/100

(57) ABSTRACT

A system and method for utilizing a remote memory device to perform an interface save/restore procedure in an electronic device includes a processor that begins to execute a first task in conjunction with a host interface of a display controller. The processor subsequently receives an interrupt request for executing a second task that has a higher priority than the first task. A save/restore module responsively creates a task handle that represents the interrupted first task states from the display controller. The processor then stores the task handle in a remote memory device that is implemented outside of the display controller to conserve memory resources of the display controller. After the second task has been completed, the processor returns the saved task handle to the save/restore module for restoring the interrupted first task states to the display controller. The display controller may then efficiently resume performing the interrupted first task.

### BACKGROUND SECTION

1. Field of Invention

This invention relates generally to electronic display controller systems, and relates more particularly to a system and method for utilizing a remote memory to perform an interface save/restore procedure.

2. Description of the Background Art

Implementing efficient methods for handling electronic data is a significant consideration for designers and manufacturers of contemporary electronic devices. However, efficiently handling data with electronic devices may create substantial challenges for system designers. For example, enhanced demands for increased device functionality and performance may require more system operating power and require additional hardware resources. An increase in power or hardware requirements may also result in a corresponding detrimental economic impact due to increased production costs and operational inefficiencies.

Furthermore, enhanced device capability to perform various advanced operations may provide additional benefits to a system user, but may also place increased demands on the control and management of various device components. For example, an enhanced electronic device that efficiently manipulates, transfers, and displays digital image data may benefit from an efficient implementation because of the large amount and complexity of the digital data involved.

Due to growing demands on system resources and substantially increasing data magnitudes, it is apparent that developing new techniques for controlling the handling of electronic data is a matter of concern for related electronic technologies. Therefore, for all the foregoing reasons, developing efficient systems for handling electronic data remains a significant consideration for designers, manufacturers, and users of contemporary electronic devices.

### SUMMARY

In accordance with the present invention, a system and method are disclosed for utilizing a remote memory device to perform an interface save/restore procedure. In one embodiment, a CPU of an electronic device begins executing a first task in conjunction with a display controller of the electronic device. For example, the CPU may communicate with the display controller via a host interface to perform the first task. The host interface is typically implemented as an economical indirect interface that handles only one task at any given time. Subsequently, the CPU receives an interrupt request from any appropriate interrupt source to perform a higher-priority second task in conjunction with the display controller.

In response to the interrupt request, the CPU initiates a save procedure by issuing a save command to the display controller. A save/restore module of the display controller responsively creates a task handle that represents current first task states from the interrupted first task in the display controller. In certain embodiments, the save/restore module saves the task handle into a local task handle register of the display controller. The CPU then accesses and stores the task handle into a remote memory device that is implemented in a manner that is external to the display controller.

The CPU then executes the higher-priority second task in conjunction with the display controller. When the second task has been successfully completed, the CPU initiates a restore procedure by transferring the saved task handle back to the local task handle register of the display controller. The save/restore module of the display controller then interprets the task handle to restore the interrupted first task states to the host interface (or other appropriate entity). Finally, the CPU and display controller may resume executing the interrupted first task with all corresponding states, values, and conditions being the same as when the first task was originally interrupted in favor of higher-priority second task.

For at least the reason that the remote memory device may be implemented to accommodate any number of task handles without impacting the amount of memory required in the display controller, the foregoing save/restore procedure may be extended to support any desired number of interrupted tasks by utilizing multi-tiered save/restore procedures. For at least the foregoing reasons, the present invention provides an improved system and method for utilizing a remote memory device to perform an interface save/restore procedure.

### BRIEF DESCRIPTION OF THE DRAWINGS

FIG. 1 is a block diagram for one embodiment of an electronic device, in accordance with the present invention;

FIG. 2 is a block diagram for one embodiment of the display controller of FIG. 1, in accordance with the present invention;

FIG. 3 is a block diagram for one embodiment of the video memory of FIG. 2, in accordance with the present invention;

FIG. 4 is a block diagram for one embodiment of the controller registers of FIG. 2, in accordance with the present invention;

FIG. 5 is a block diagram for one embodiment of the display of FIG. 1, in accordance with the present invention;

FIG. 6 is a block diagram for one embodiment of the task handles of FIG. 1, in accordance with the present invention;

FIG. 7 is a flowchart of method steps for performing an interface save/restore procedure, in accordance with one embodiment the present invention;

FIG. 8 is a diagram illustrating a multi-tiered interface save/restore procedure, in accordance with one embodiment of the present invention;

FIG. 9 is a diagram for one embodiment of an exemplary task handle from FIG. 6, in accordance with the present invention;

FIG. 10 is a flowchart of method steps for performing an interface save procedure, in accordance with one embodiment the present invention; and

FIG. 11 is a flowchart of method steps for performing an interface restore procedure, in accordance with one embodiment the present invention.

### DETAILED DESCRIPTION

The present invention relates to an improvement in display controller systems. The following description is presented to enable one of ordinary skill in the art to make and use the invention, and is provided in the context of a patent application and its requirements. Various modifications to the embodiments disclosed herein will be apparent to those skilled in the art, and the generic principles herein may be applied to other embodiments. Thus, the present invention is not intended to be limited to the embodiments shown, but is to be accorded the widest scope consistent with the principles and features described herein.

The present invention comprises a system and method for utilizing a remote memory device to perform an interface save/restore procedure in an electronic device, and includes a processor that initially begins to execute a first task in conjunction with a host interface of a display controller. The processor subsequently receives an interrupt request for executing a second task that has a higher priority than the first task. A save/restore module responsively creates a task handle that represents the interrupted first task states of the display controller.

The processor then stores the task handle in a remote memory device that is implemented outside of the display controller to conserve memory resources of the display controller. After the second task has been completed, the processor returns the saved task handle to the save/restore module for restoring the interrupted first task states of the display controller. The display controller may then efficiently resume performing the interrupted first task.

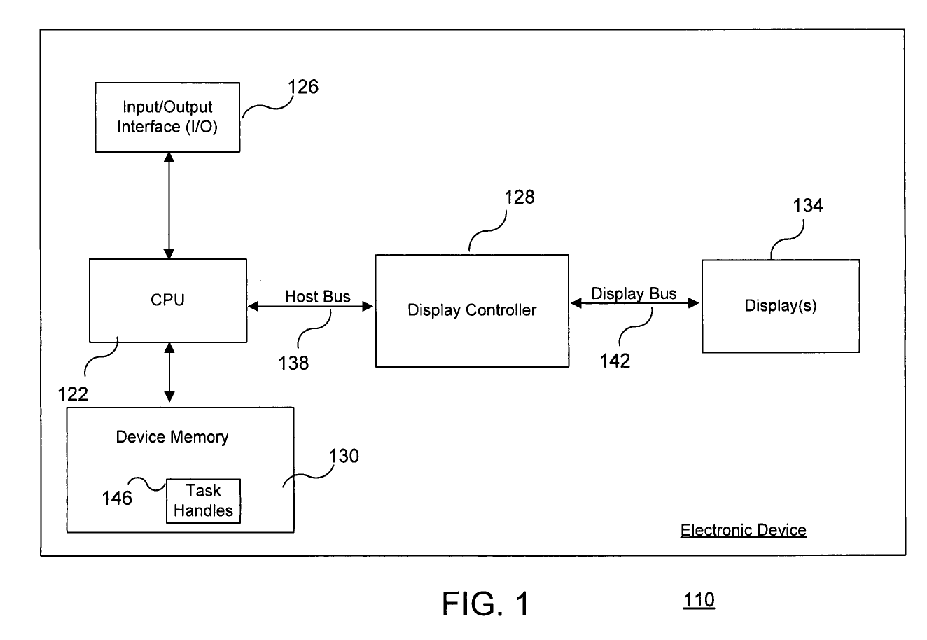

Referring now to FIG. 1, a block diagram for one embodiment of an electronic device 10 is shown, according to the present invention. The FIG. 1 embodiment includes, but is not limited to, a central processing unit (CPU) 122, an input/output interface (I/O) 126, a display controller 128, a device memory 130, and one or more display(s) 134. In alternate embodiments, electronic device 110 may include elements or functionalities in addition to, or instead of, certain of the elements or functionalities discussed in conjunction with the FIG. 1 embodiment.

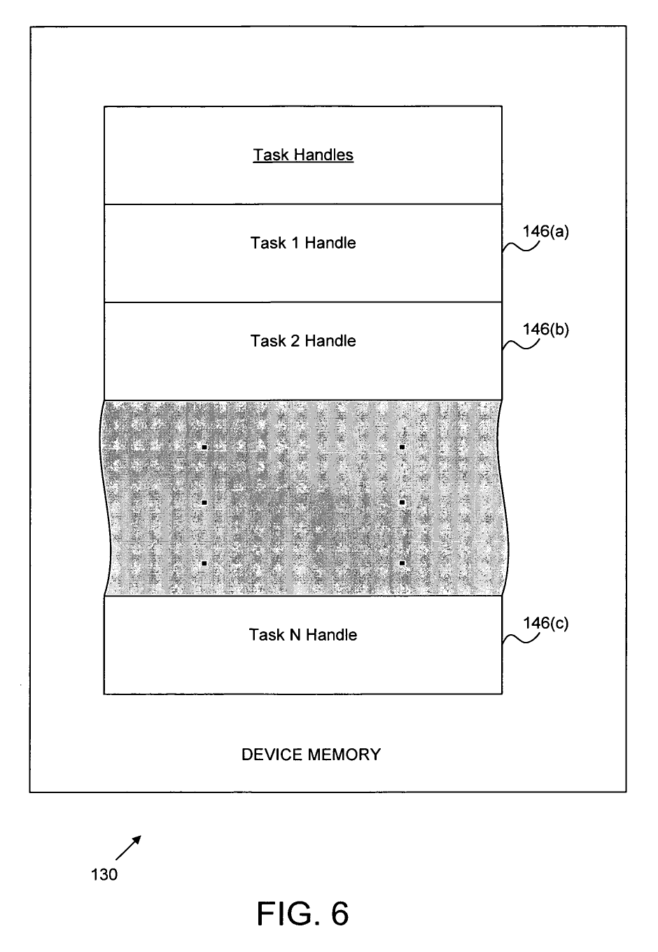

In the FIG. 1 embodiment, CPU 122 may be implemented as any appropriate and effective processor device or microprocessor to thereby control and coordinate the operation of electronic device 110 in response to various software program instructions. In the FIG. 1 embodiment, device memory 130 may comprise any desired storage-device configurations, including, but not limited to, random access memory (RAM), read-only memory (ROM), and storage devices such as removable memory or hard disk drives. In the FIG. 1 embodiment, device memory 130 may include, but is not limited to, one or more task handles 146 that represent saved states of an interrupted task of display controller 128. The utilization of device memory 130 to advantageously store task handles 130 in a manner that is external to display controller 128 is further discussed below in conjunction with FIGS. 6-11.

In the FIG. 1 embodiment, a device application (not shown) may include program instructions for allowing CPU 122 to provide image data and corresponding transfer and display information via host bus 138 to display controller 128. In accordance with the present invention, display controller 128 then responsively provides the received image data via display bus 142 to at least one of the display(s) 134 of electronic device 110. In the FIG. 1 embodiment, input/output interface (I/O) 126 may include one or more interfaces to receive and/or transmit any required types of information to or from electronic device 110. Input/output interface 126 may include one or more means for allowing a device user to communicate with electronic device 110. In addition, various external electronic devices may communicate with electronic device 110 through I/O 126. For example, a digital imaging device, such as a digital camera, may utilize input/output interface 126 to provide captured image data to electronic device 110.

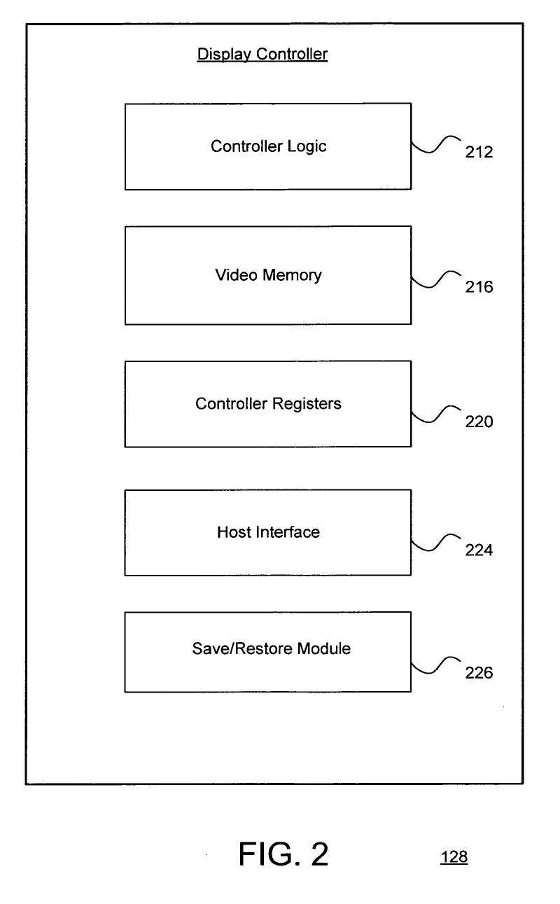

In the FIG. 1 embodiment, electronic device 110 may utilize display controller 128 for efficiently managing various tasks and functionalities relating to display(s) 134. The implementation and functionality of display controller 128 is further discussed below in conjunction with FIGS. 2-4 and 6-11. In the FIG. 1 embodiment, electronic device 110 may be implemented as any desired type of electronic device or system. For example, in certain embodiments, electronic device 110 may alternately be implemented as a cellular telephone, a personal digital assistant device, an electronic imaging device, or a computer device. Various embodiments for the operation and utilization of electronic device 110 are further discussed below in conjunction with FIGS. 2-11.

Referring now to FIG. 2, a block diagram for one embodiment of the FIG. 1 display controller 128 is shown, in accordance with the present invention. The FIG. 2 embodiment includes, but is not limited to, controller logic 212, video memory 216, controller registers 220, a host interface 224, and a save/restore module 226. In alternate embodiments, display controller 128 may include elements or functionalities in addition to, or instead of, certain of the elements or functionalities discussed in conjunction with the FIG. 2 embodiment. For purposes of illustration, the FIG. 2 embodiment is discussed in the context of a display controller, however, in certain alternate embodiments, the present invention may readily be practiced in conjunction with any type of electronic device or controller that communicates with another entity (such as CPU 122 of FIG. 1) by utilizing an indirect host interface.

In the FIG. 2 embodiment, display controller 128 may be implemented as an integrated circuit device that accepts image data and corresponding transfer and display information from CPU 122 (FIG. 1) to perform corresponding data processing and data transfer tasks. Display controller 128 then automatically provides the received image data to display 134 of electronic device 110 in an appropriate and efficient manner for displaying to a device user. In the FIG. 2 embodiment, controller logic 212 manages and coordinates the overall operation of display controller 128. In the FIG. 2 embodiment, display controller 128 may utilize controller registers 220 to store various types of configuration, control and status information.

In the FIG. 2 embodiment, display controller 128 utilizes host interface 224 to perform bi-directional communications with CPU 122 via a host bus 138 (FIG. 1). In certain embodiments, in order to implement host interface 224 and host bus 138 in an efficient, space-saving, and economical manner, host interface 224 typically receives/transmits information corresponding to only a single processing task at any given time by utilizing indirect interface techniques. For example, in certain indirect interface operations, CPU 122 may perform a data write task to transfer data to display controller 128. Alternately, CPU 122 may perform a data read task to access data from display controller 128.

In accordance with the present invention, display controller 128 may advantageously utilize save/restore module 226 to save interface states from host interface 224 (or other appropriate source) as a corresponding task handle 146 (FIG. 1) whenever a given lower-priority task must be interrupted in order to service another higher-priority task in display controller 128. After the higher-priority task has been executed, display controller may then utilize the task handle 146 to restore the saved interface states to host interface 224 (or other appropriate source) in order to efficiently and effectively complete the interrupted lower-priority task.

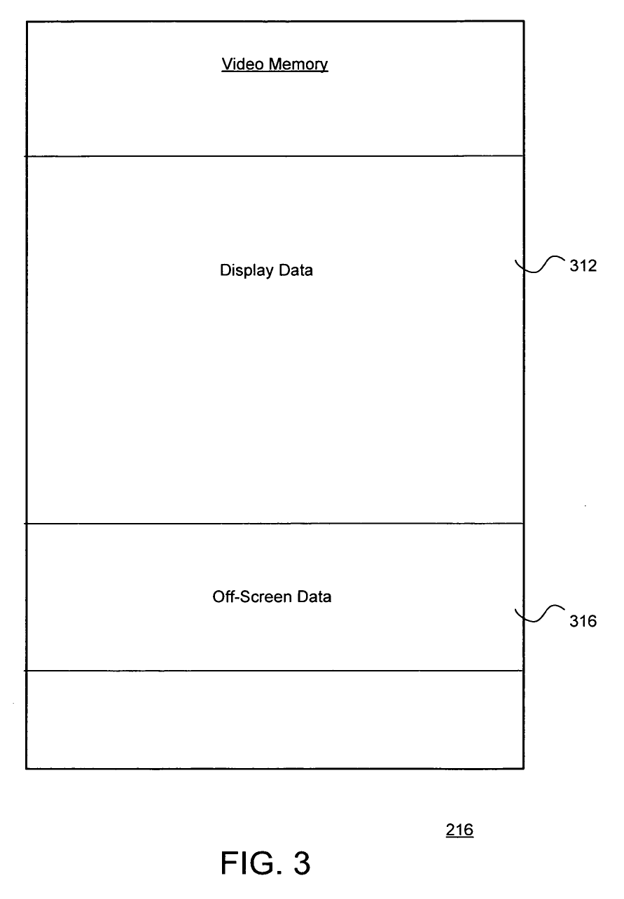

In accordance with one embodiment of the present invention, CPU 122 (FIG. 1) may save the task handle 146 in remote memory device 130 (FIG. 1) in a manner that is external to display controller 128. Storing task handles 146 in remote memory device 130 permits display controller 128 to be implemented in a more economical manner because of the reduced amount of internal memory required. In addition, the relatively substantial size of remote memory device 130 allows the nesting of a larger number of task handles 146 for a significantly greater number of interrupted tasks of display controller 128 without the danger of exhausting available memory resources. The utilization of display controller is further discussed below in conjunction with FIGS. 3-8.

Referring now to FIG. 3, a block diagram for one embodiment of the FIG. 2 video memory 216 is shown, in accordance with the present invention. In the FIG. 3 embodiment, video memory 216 includes, but is not limited to, display data 312 and off-screen data 316. In alternate embodiments, video memory 216 may include elements and functionalities in addition to, or instead of, certain of the elements and functionalities discussed in conjunction with the FIG. 3 embodiment.

In the FIG. 3 embodiment, video memory 216 may be implemented by utilizing any effective types of memory devices or configurations. For example, in certain embodiments, video memory 216 may be implemented as a random-access memory (RAM) device. In the FIG. 3 embodiment, display data 312 may include image data that is provided by CPU 122 or other appropriate source. In the FIG. 3 embodiment, off-screen data 316 may include any appropriate type of information or data that is not intended for presentation upon display 134 of electronic device 110. For example, off-screen data 316 may be utilized to cache certain fonts or other objects for use by display controller 128.

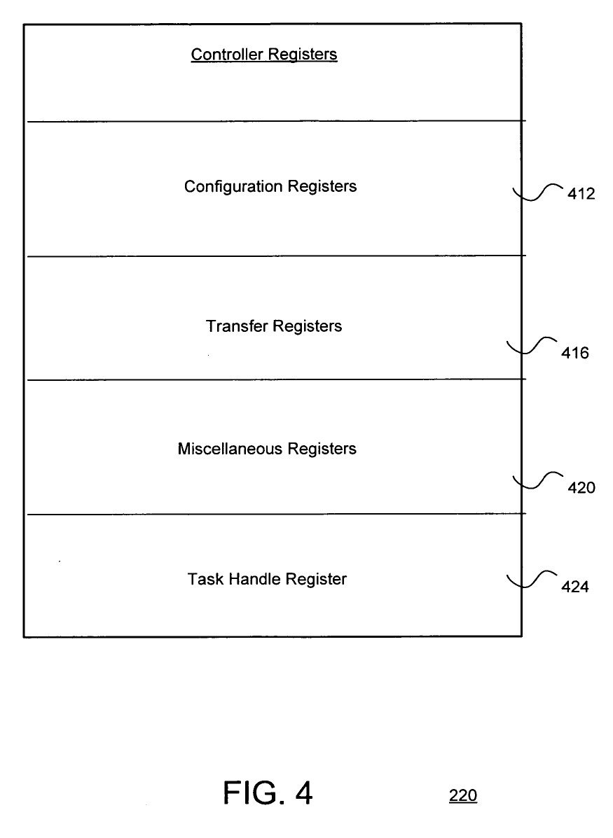

Referring now to FIG. 4, a block diagram for one embodiment of the FIG. 2 controller registers 220 is shown, in accordance with the present invention. In the FIG. 4 embodiment, controller registers 220 include, but are not limited to, configuration registers 412, transfer registers 416, miscellaneous registers 420, and a task handle register 424. In alternate embodiments, controller registers 220 may include elements and functionalities in addition to, or instead of, certain of the elements and functionalities discussed in conjunction with the FIG. 4 embodiment.

In the FIG. 4 embodiment, CPU 122 (FIG. 1) or other appropriate entities may write information into controller registers 220 to specify various types of operational parameters and other relevant information for use by controller logic 212 of display controller 128. In the FIG. 4 embodiment, controller registers 220 may utilize configuration registers 412 for storing various types of information relating to the configuration of display controller 128 and/or display 134 of electronic device 110. For example, configuration registers 220 may specify a display type, a display size, a display frame rate, and various display timing parameters. In the FIG. 4 embodiment, controller registers 220 may utilize transfer registers 416 for storing various types of information relating to transfer operations for providing pixel data from video memory 216 (FIG. 3) to display 134 of electronic device 110. In the FIG. 4 embodiment, controller registers 220 may utilize miscellaneous registers 420 for effectively storing any desired type of information or data for use by display controller 128.

In the FIG. 4 embodiment, controller registers 220 may advantageously utilize task handle register 424 as a dedicated register for temporarily storing a task handle 146 corresponding to a given interrupted task from display controller 128. If a current task is interrupted, CPU 122 (or other appropriate entity) may initiate a save procedure in which the current task handle 146 is read from task handle register 424. The task handle 146 is then stored remotely into device memory 130 (FIG. 1) for subsequent use. In accordance with the present invention, CPU 122 need not know how to interpret or utilize the stored task handle 146 because display controller 128 will perform those functions.

When the interrupted task is ready to be resumed by display controller 128, CPU 122 may initiate a restore procedure in which the appropriate task handle 146 is written from device memory 130 into task handle register 424. The save/restore module 226 of display controller 128 may then access task handle register 424, and may interpret the task handle 146 in an appropriate manner to determine the interrupted task states. Save/restore module 226 may then repopulate the host interface 224 (or other entities) with the interrupted task states to return display controller 128 to the exact overall condition prior to the interruption.

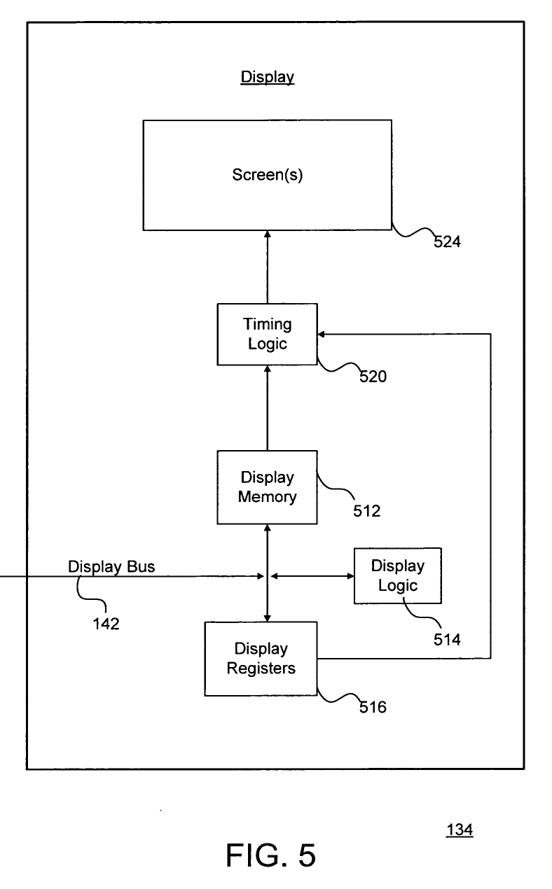

Referring now to FIG. 5, a block diagram for one embodiment of the FIG. 1 display 134 is shown, in accordance with the present invention. In the FIG. 5 embodiment, display 134 includes, but is not limited to, a display memory 512, display logic 514, display registers 516, timing logic 520, and one or more screen(s) 524. In alternate embodiments, display 134 may include elements and functionalities in addition to, or instead of, certain of the elements and functionalities discussed in conjunction with the FIG. 5 embodiment.

In the FIG. 5 embodiment, display 134 is implemented as a random-access-memory based liquid-crystal display panel (RAM-based LCD panel). However, in alternate embodiments, display 134 may be implemented by utilizing any type of appropriate display technologies or configurations. In the FIG. 5 embodiment, display controller 128 provides various types of display information to display registers 516 via display bus 142. Display registers 516 may then utilize the received display information for effectively controlling timing logic 520. In the FIG. 5 embodiment, display logic 514 manages and coordinates data transfer and display functions for display 134.

In the FIG. 5 embodiment, display controller 128 provides image data from video memory 216 (FIG. 2) to display memory 512 via display bus 142. In the FIG. 5 embodiment, display memory 512 is typically implemented as random-access memory (RAM). However, in various other embodiments, any effective types or configurations of memory devices may be utilized to implement display memory 512. In the FIG. 5 embodiment, display memory 512 then advantageously provides the image data received from display controller 128 to one or more screens 524 via timing logic 520 for viewing by a device user of electronic device 110.

Referring now to FIG. 6, a block diagram for one embodiment of the FIG. 1 task handles 146 is shown, in accordance with one embodiment of the present invention. In alternate embodiments, task handles 146 may readily be implemented using components and configurations in addition to, or instead of, certain those components and configurations discussed in conjunction with the FIG. 6 embodiment.

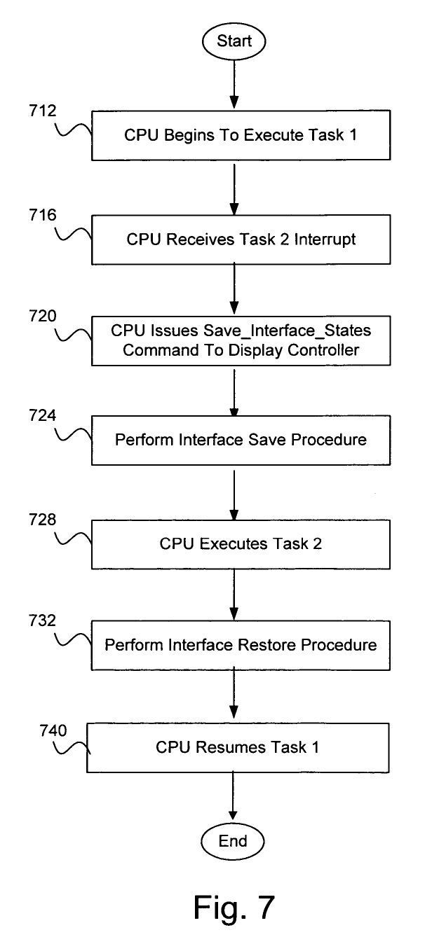

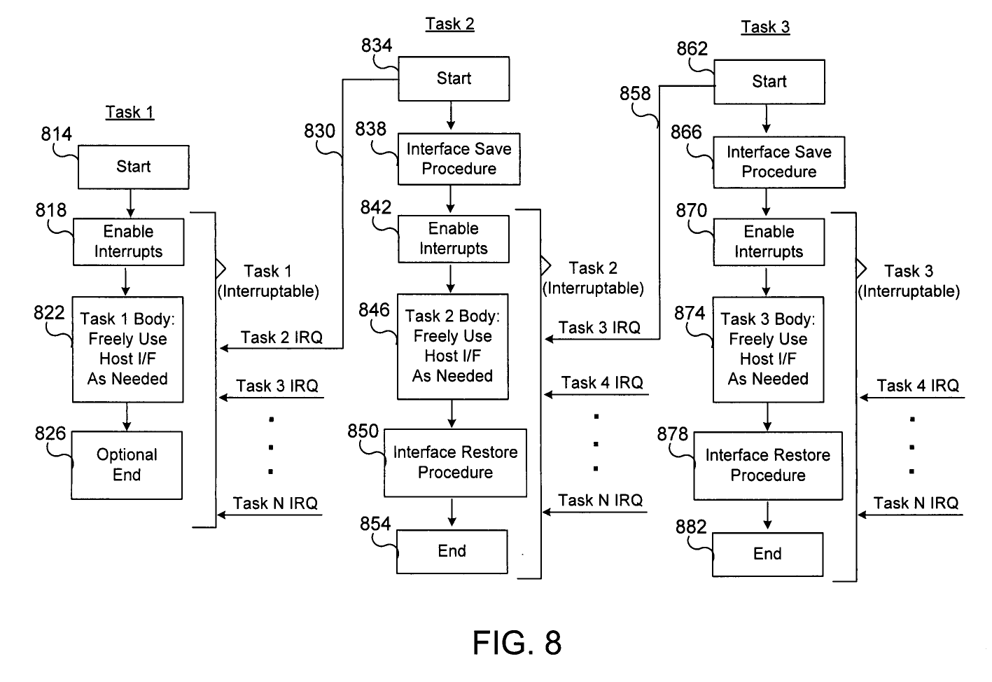

In the FIG. 6 embodiment, task handles 146 may include a task 1 handle 146(a) through a task N handle 146(c) that each correspond to a different respective processing task that is currently interrupted in favor of a higher-priority processing task. Task handles 146 may include representations of any desired type of information from host interface 224 or any other appropriate entity. For example, task handles 146 may include representations of register values, addresses, pre-fetched information, counter values, and internal values. In certain embodiments, host interface 224 may be implemented as a state machine, and task handles 146 may represent current state values from the state machine. The utilization of task handles 146 is further discussed below in conjunction with FIGS. 7 and 8.

Referring now to FIG. 7, a flowchart of method steps for performing an interface save/restore procedure is shown, in accordance with one embodiment of the present invention. The FIG. 7 example is presented for purposes of illustration, and in alternate embodiments, the present invention may readily utilize steps and sequences other than certain of those steps and sequences discussed in conjunction with the FIG. 7 embodiment.

In the FIG. 7 embodiment, in step 712, CPU 122 (FIG. 1) begins executing a task 1 in conjunction with display controller 128 (FIG. 1). For example, CPU 122 may communicate with display controller 128 via a host interface 224 (FIG. 2) to perform task 1. In step 716, CPU 122 receives a task 2 interrupt from any appropriate interrupt source to perform a higher-priority task 2 in conjunction with display controller 128.

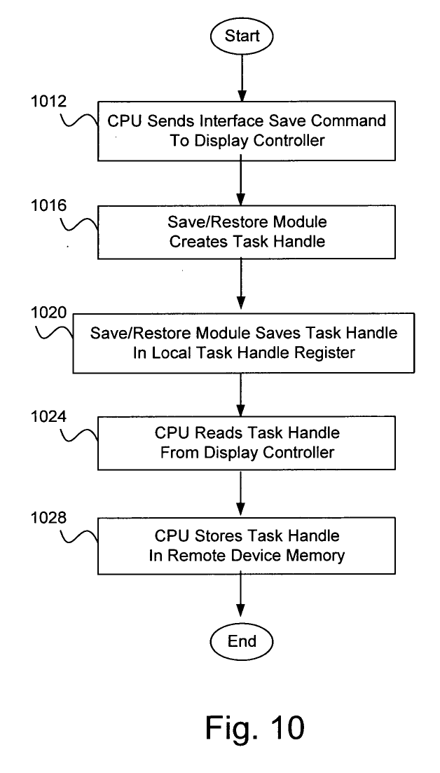

In response to the task 2 interrupt, in step 720, CPU 122 issues a Save_Interface_States command to display controller 128. In step 724, electronic device 110 performs an interface save procedure to save a task handle 146 representing the current states of display controller 128 into remote memory device 130. The foregoing interface save procedure is further discussed below in conjunction with FIG. 10.

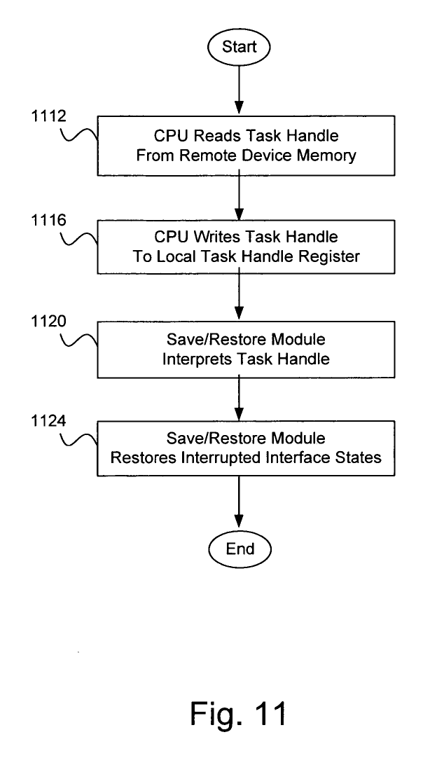

In step 728, CPU 122 performs higher-priority task 2 in conjunction with display controller 128. In step 732, when task 2 has been successfully completed, electronic device 110 performs an interface restore procedure to restore display controller 128 to a pre-interruption condition with respect to task 1. The foregoing interface restore procedure is further discussed below in conjunction with FIG. 11. Finally, in step 740, CPU 122 may resume executing the interrupted task 1 with all corresponding states, values, and conditions being the same as when task 1 was originally interrupted.

The FIG. 7 embodiment discusses performing a save/restore procedure for a display controller 128. However, in alternate embodiments, the save/restore procedure may be effectively utilized in conjunction with any other type of appropriate device. In addition, the FIG. 7 embodiment is presented in the context of a single higher-priority task. However, because of the extensive storage capacity of device memory 130 for storing multiple task handles 146, the present invention may be extended to support any desired number of interrupted tasks by utilizing multi-tiered save/restore procedures. One exemplary embodiment illustrating multi-tiered save/restore procedures is further discussed below in conjunction with FIG. 8.

Referring now to FIG. 8, a diagram illustrating a multi-tiered interface save/restore procedure is shown, in accordance with one embodiment of the present invention. The FIG. 8 example is presented for purposes of illustration, and in alternate embodiments, the present invention may readily utilize techniques and sequences other than certain of those techniques and sequences discussed in conjunction with the FIG. 8 embodiment.

In the FIG. 8 embodiment, in step 814, CPU 122 and display controller 128 of electronic device 110 start task 1, and in step 818, task 1 interrupts are enabled for any task with the same or higher priority than task 1. In step 822, during the task 1 body, CPU 122 freely uses the host interface 224 of display controller 128 as needed to perform task 1. Task 1 is interruptable by a task 2 interrupt (IRQ) through a task N interrupt (IRQ).

In the FIG. 8 embodiment, while task 1 is executing, CPU 122 receives a task 2 interrupt (IRQ) 830 from a task 2 that has a higher priority level than currently-executing task 1. CPU 122 and display controller 128 responsively start task 2 in step 834. In step 838, electronic device 110 performs an interface save procedure to remotely store a task 1 handle into a remote memory device 130 (FIG. 1). In step 842, task 2 interrupts are enabled for any task with the same or higher priority than task 2. In step 846, during the task 2 body, CPU 122 freely uses the host interface 224 of display controller 128 as needed to perform task 2. Task 2 is interruptable by a task 3 interrupt (IRQ) through a task N interrupt (IRQ).

In the FIG. 8 embodiment, while task 2 is executing, CPU 122 receives a task 3 interrupt (IRQ) 858 from a task 3 that has a higher priority level than currently-executing task 2. CPU 122 and display controller 128 responsively start task 3 in step 862. In step 866, electronic device 110 performs an interface save procedure to remotely store a task 2 handle into remote memory device 130. In step 870, task 3 interrupts are enabled for any task with the same or higher priority than task 3. In step 874, during the task 3 body, CPU 122 freely uses the host interface 224 of display controller 128 as needed to perform task 3. Task 3 is interruptable by a task 4 interrupt (IRQ) through a task N interrupt (IRQ).

In step 878, after task 3 has been successfully completed, electronic device 110 performs an interface restore procedure that utilizes the task 2 handle 146 from memory device 130 to repopulate interrupted task 2 states in display controller 128. In the FIG. 8 embodiment, when display controller 128 receives a given Restore_Interface_States command from CPU 122 to initiate the interface restore procedure, display controller 128 restores the most recently-stored set of task states 614 from interface states 228 to host interface 224.

In the FIG. 8 embodiment, after display controller 128 restores task 2 states to host interface 224, CPU 122 and display controller 128 may then resume executing the interrupted task 2 body in step 846. In step 850, after task 2 has been successfully completed, electronic device 110 performs an interface restore procedure that utilizes the task 1 handle 146 from memory device 130 to repopulate interrupted task 1 states in display controller 128.

In the FIG. 8 embodiment, after display controller 128 restores task 1 states to host interface 224, CPU 122 and display controller 128 may then resume executing the interrupted task 1 body in step 822. For at least the foregoing reasons, the present invention provides an improved system and method for performing an interface save/restore procedure in an electronic device.

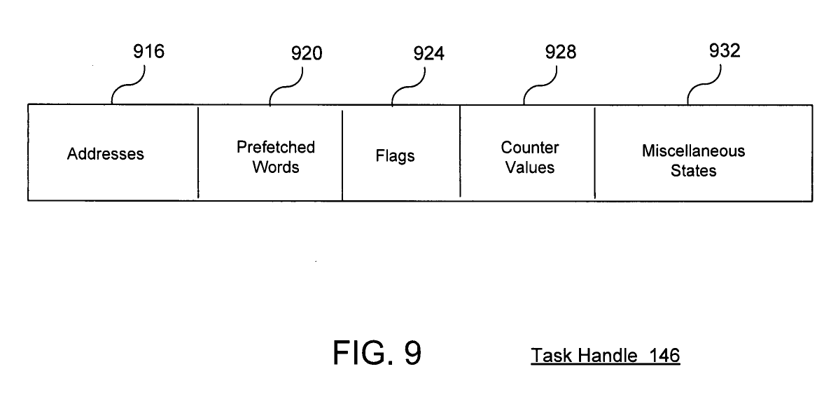

Referring now to FIG. 9, a diagram for one embodiment of an exemplary FIG. 6 task handle 146 is shown, in accordance with one embodiment of the present invention. The FIG. 9 embodiment is presented for purposes of illustration, and in alternate embodiments, task handles 146 may readily be implemented using components and configurations in addition to, or instead of, certain those components and configurations discussed in conjunction with the FIG. 9 embodiment.

In the FIG. 9 embodiment, task handle 146 may include any type of information that represents conditions or states of host interface 224 (FIG. 2), display controller 128, or any other appropriate entity, with respect to a given task that is performed by display controller 128 (usually in conjunction with CPU 122). In the FIG. 9 embodiment, task handle 146 may be implemented as the original raw values of the corresponding task states. Therefore, task handle 146 may be implemented as a simple string of numbers.

Alternatively, task handle 146 may be formatted by display controller 128 or other appropriate entity in a manner that represents the corresponding states by utilizing any desired encoding techniques. Because display controller 128 creates and saves a given task handle 146 into task handle register 424 (FIG. 4), display controller 128 therefore is able to accurately interpret that particular task handle 146 during an interface restore procedure.

In the FIG. 9 embodiment, the individual states represented by task handle 146 may include any relevant or desired conditions, internal register values, or states corresponding to a given task. For example, in the FIG. 9 example, task handle 146 includes information that represents one or more addresses 916, one or more prefetched words 920, one or more flags 924, one or more counter values 928, and various other miscellaneous states 932. The utilization of task handle 146 is further discussed below in conjunction with FIGS. 10 and 11.

Referring now to FIG. 10, a flowchart of method steps for performing an interface save procedure is shown, in accordance with one embodiment of the present invention. The FIG. 10 example is presented for purposes of illustration, and in alternate embodiments, the present invention may readily utilize steps and sequences other than certain of those steps and sequences discussed in conjunction with the FIG. 10 embodiment.

In the FIG. 10 embodiment, in step 1012, CPU 122 (FIG. 1) of electronic device 110 sends an interface save command to display controller 128. In response, in step 1016, a save/restore module 226 of the display controller 128 creates and stores a task handle 146 that represents task states and conditions of a current task that is being interrupted in display controller 128.

In step 1020, save/restore module 226 then saves the task handle 146 into a local task handle register 424 of display controller 128. In step 1024, CPU 122 (FIG. 1) reads the task handle 146 from the task handle register 424 of display controller 128. Finally, in step 1028, CPU 122 stores the task handle 146 in a remote device memory 130 that is implemented externally with respect to display controller 128. The interface save procedure of FIG. 10 may then terminate.

Referring now to FIG. 11, a flowchart of method steps for performing an interface restore procedure is shown, in accordance with one embodiment of the present invention. The FIG. 11 example is presented for purposes of illustration, and in alternate embodiments, the present invention may readily utilize steps and sequences other than certain of those steps and sequences discussed in conjunction with the FIG. 11 embodiment.

In the FIG. 11 embodiment, after an interrupting priority task has been completed, then in step 1112, CPU 122 reads an appropriate task handle 146 for the most-recently interrupted task from remote device memory 130 (FIG. 1). In step 1116, CPU 112 writes the task handle 146 into a local task handle register 424 of display controller 128.

In step 1120, a save/restore module 226 of display controller 128 interprets the task handle 146 that was written into the local task handle register 424 by CPU 122 to produce the original interrupted task states for the interrupted task. Finally, in step 1124, the save/restore module 226 restores the original interrupted task states to appropriate locations of display controller 128 so that display controller 128 may resume execution of the interrupted task. For at least the foregoing reasons, the present invention provides and improved system and method for utilizing a remote memory to perform an interface save/restore procedure.

The invention has been explained above with reference to certain preferred embodiments. Other embodiments will be apparent to those skilled in the art in light of this disclosure. For example, the present invention may be implemented using certain configurations and techniques other than those described in the embodiments above. Additionally, the present invention may effectively be used in conjunction with systems other than those described above as the preferred embodiments. Therefore, these and other variations upon the foregoing embodiments are intended to be covered by the present invention, which is limited only by the appended claims.

What is claimed is:

1. A method for performing a save/restore procedure for an electronic device, comprising the steps of:
receiving a save command with a controller device that responsively interrupts a first task that is current being executed;
utilizing a save/restore module of said controller device to create a first task handle that represents first task states corresponding to said first task;
storing said first task handle in a remote memory device that is implemented outside of said controller device;
accessing said first task handle from said remote memory device when a second task has been completed, said second task having a higher priority level than said first task;
interpreting said first task handle with said save/restore module to recreate said first task states in said controller device; and
resuming said first task with said controller device.

2. The method of claim 1 wherein said controller device is implemented as a display controller integrated-circuit device that includes said save/restore module, said first task states including interrupted interface states from a host interface of said display controller.

3. The method of claim 1 wherein a processor of said electronic device issues said save command to said controller device in response to an interrupt request for executing said second task, said processor saving said first task handle into said remote memory device, said processor providing said first task handle to said controller device when said second task has been completed.

4. The method of claim 3 wherein said save/restore module saves said first task handle into a local task handle register of said controller device so that said processor can access said first task handle to perform an interface save procedure, said processor subsequently writing said first task handle into said local task handle register after said second task has been completed, so that said save/restore module can perform an interface restore procedure.

5. The method of claim 3 wherein said display controller functions as an interface between said processor and a display device in a portable electronic device.

6. The method of claim 3 wherein said processor issues a save command to said controller device to instruct said save/restore module to create and store said first task handle.

7. The method of claim 3 wherein said processor issues a restore command to said controller device to instruct said save/restore module to interpret said first task handle for restoring said first task states after said second task is completed.

8. The method of claim 1 wherein said first task handle represents first task states that include at least one of addresses, register values, flags, counter values, pre-fetched words, and internal controller values.

9. The method of claim 3 wherein said interrupt request is generated from an interrupt source coupled to said electronic device to request immediate execution of said second task by said processor in conjunction with said controller device, only one of said first task and said second task being executable by said controller device during a given time period.

10. The method of claim 3 wherein said first task and said second task include transferring information between said processor and said controller device to support displaying image data on a display of said electronic device.

11. The method of claim 3 wherein said processor resumes said first task with said controller device having an operating status that is identical to when said first task was interrupted to execute said second task.

12. The method of claim 1 wherein said save/restore module supports a multi-tiered hierarchy of interrupted processing tasks with corresponding saved task handles in addition to said first task handle of said first task and said second task handle of said second task.

13. The method of claim 12 wherein a restore command from said processor causes said save/restore module to restore a saved set of task states to said display controller.

14. The method of claim 3 wherein said processor receives a second interrupt request for executing a third task that has a higher priority than said second task, said save/restore module responsively creating a second task handle that represents second task states of said display controller, said processor storing said second task handle into said remote memory device, said second task states corresponding to an interrupted execution point in said second task.

15. The method of claim 14 wherein said processor temporarily stops said second task to execute said third task, said save/restore module interprets said second task handle to restore said second task states to said controller device after said third task is completed, said processor then resuming said second task.

16. A system for performing a save/restore procedure in an electronic device, comprising:
a save/restore module that creates a first task handle to represent first task states when a first task is temporarily interrupted to execute a second task, said first task states being from a host interface of a controller device that performs said first task and said second task, said first task states corresponding to an interrupted execution point in said first task, said first task handle being stored in a remote memory device that is external to said controller device, said save/restore module accessing and interpreting said first task handle to restore said first task states to said host interface after said second task is completed, said controller device then resuming said first task.

17. A method for performing a save/restore procedure, comprising:
utilizing a controller device to create a task handle that represents task states from a first task that is interrupted to execute a second task that has a higher priority level than said first task;
storing said first task handle in a remote memory device that is implemented outside of said controller device;
accessing said first task handle to recreate said first task states in said controller device after said second task has been completed; and
resuming said first task with said controller device.
